(19) United States
(12) Patent Application Publication
(10) Pub. No.: US 2025/0197120 A1
(43) Pub. Date: Jun. 19, 2025

(54) PICKING MANAGEMENT DEVICE, PICKING MANAGEMENT METHOD, AND NON-TRANSITORY COMPUTER-READABLE MEDIUM THEREOF

(71) Applicant: WPG Holdings Co., Ltd., Taipei City (TW)

(72) Inventors: CHIH-WEI HSIEH, Taipei City (TW); KUN-HUNG LEE, Taipei City (TW); ZI-YOU LIN, Taipei City (TW)

(21) Appl. No.: 18/981,275

(22) Filed: Dec. 13, 2024

Related U.S. Application Data
(60) Provisional application No. 63/610,647, filed on Dec. 15, 2023.

(51) Int. Cl. B65G 1/137; G06Q 10/047; G06Q 10/087

(52) U.S. Cl. CPC B65G 1/1373; B65G 1/1371; G06Q 10/047; G06Q 10/087

(57) ABSTRACT

A picking management device performs the following steps: (A) determining from data of storage space to be picked, a storage space closest to a current location, updating the current location, and then removing the storage space from the data of storage space to be picked; (B) determining the closest storage space in the same aisle as the current location, updating the current location and then removing the storage space; (C) repeating step (B) until there is no longer any storage space in the same aisle as the current location in the data of storage space to be picked; (D) repeating steps (A), (B), and (C) until the data of the storage space to be picked is cleared, and generating a picking sequence based on a change history of the current location; and (E) providing the picking sequence to a terminal equipment, so that the equipment performs picking operations accordingly.

### PRIORITY

This application claims priority to U.S. Provisional Applications No. 63/610,647 filed on Dec. 15, 2023, the entire contents of which are incorporated herein by reference.

### FIELD

The present invention relates to a device and a method for logistics operation management and a non-transitory computer-readable medium thereof. More specifically, the present invention relates to a picking management device, a picking management method and a non-transitory computer-readable medium thereof.

### BACKGROUND

Picking is a crucial stage in the field of logistics processing. In this stage, pickers and/or automated picking machines take out corresponding goods from storage spaces of a warehouse to the goods collection area for packaging according to requirements listed in orders, so as to facilitate the subsequent distribution. When assigning picking tasks, a type of traditional picking management systems assign tasks simply according to the contents of goods on the orders and warehouses and fields to which pickers and picking machines are allocated without providing the pickers with any hints on picking paths (that is, how to pick goods), so pickers have to arrange picking paths based on their own experience or intuition about the picking field.

Although some other types of traditional picking management systems have the function of providing path arrangement tips, they simply arrange picking paths based on general path algorithms, which leads to the decline of picking efficiency in extreme cases. Specifically, each field in a warehouse includes aisles and storage spaces (e.g., shelves, containers, and other apparatuses for storing goods). In order to maximize the utilization of space in each field, logistics operators tend to prioritize the allocation of space for storage spaces and aisles (especially storage spaces) during spatial planning, which is at the expense of the spaciousness of transition spaces between any two adjacent aisles. In other words, the number of pickers and/or picking apparatuses (e.g., trolleys) that can be accommodated in the transition space between two aisles will be significantly reduced accordingly, even to the extent that only one group of pickers and/or picking apparatuses can be accommodated in the transition space at the same time. If more than two groups of pickers and/or picking apparatuses encounter each other in this space, extra hidden costs in transportation, energy, and time, etc. will be inevitably incurred to resolve the traffic congestion.

Based on the above phenomenon, it is evident that the more cross-aisle transitions included in the picking path arranged by the picking management system, the higher the probability of incurring the hidden costs mentioned above, which in turn reduces the overall picking efficiency of the picking system. Traditional picking path planning methods focuses solely on the distances between storage spaces. Therefore, when a specific picking task involves numerous storage spaces located in different aisles but relatively close to each other, the corresponding picking route will include frequent aisle switches, leading to decreased picking efficiency.

Accordingly, an urgent need exists in the art to provide a picking management scheme so as to solve the above-mentioned technical problem of picking systems with low efficiency.

### SUMMARY

In order to at least solve the above technical problems, the present invention provides a picking management device. The picking management device may comprise a processor and a transceiver electrically connected with the processor. The processor may be configured to perform the following actions: (A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined; (B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined; (C) repeating action (B) until there is no longer any storage space to be picked in the same aisle as the current location in the data of storage space to be picked; and (D) repeating action (A), action (B), and action (C) until the data of storage space to be picked is cleared, and generating picking sequence data based on a change history of the current location. The transceiver may be configured to provide the picking sequence data to a picking terminal apparatus, so that the picking terminal apparatus performs picking operations accordingly in the target field.

In addition, in order to at least solve the above technical problems, the present invention further provides a picking management method. The picking management method may be executed by a computing device and may comprise the following steps:
(A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined;
(B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined;
(C) repeating step (B) until there is no longer any storage space to be picked in the same aisle as the current location in the data of storage space to be picked;
(D) repeating step (A), step (B), and step (C) until the data of storage space to be picked is cleared, and generating a picking sequence data based on a change history of the current location; and
(E) providing the picking sequence data to a picking terminal apparatus, so that the picking terminal apparatus performs picking operations accordingly in the target field.

In addition, in order to at least solve the above technical problems, the present invention further provides a non-transitory computer-readable medium. The non-transitory computer-readable medium, after being loaded in a computing device, may cause the computing device to read instructions in the non-transitory computer-readable medium so as to execute the above-mentioned picking management method.

In summary, the picking management device, the picking management method and the non-transitory computer-readable medium thereof provided according to the present invention focus on processing storage spaces to be picked in the same aisle first, and then processing storage spaces to be picked in other aisles, thereby minimizing the cross-aisle path arrangements in the planned picking path. Therefore, the picking management device, the picking management method and the non-transitory computer-readable medium thereof provided according to the present invention effectively address the technical issue of poor picking efficiency in traditional picking management systems regarding route planning.

This summary overall describes the core concept of the present invention, and covers the problem to be solved, the means to solve the problem and the effect of the present invention to provide a basic understanding of the present invention by those of ordinary skill in the art. However, it shall be appreciated that, this summary is not intended to encompass all embodiments of the present invention but is provided only to present the core concept of the present invention in a simple form and as an introduction to the detailed description that follows. The detailed technology and embodiments implemented for the present invention are described in the following paragraphs accompanying the appended drawings for those of ordinary skill in the art to well appreciate the technical features claimed in the present invention.

### BRIEF DESCRIPTION OF THE DRAWINGS

FIG. 1 is a schematic view of a picking management device according to one or more embodiments of the present invention.

FIG. 2A is a flowchart diagram of the picking management device shown in FIG. 1 performing picking path arrangement.

FIG. 2B is a schematic view of a table demonstrating the format of Consolidation ID according to one or more embodiments of the present invention.

FIG. 2C is a schematic view of a table demonstrating a way of customization available to the Time-place section shown in the table of FIG. 2B.

FIG. 3A is a schematic view of the picking management device shown in FIG. 1 performing cross-field cooperation.

FIG. 3B is a schematic view of a table demonstrating a way of field-mapping according to one or more embodiments of the present invention.

FIG. 4 is a floor plan generated for storage spaces and aisles in a picking field by the picking management device shown in FIG. 1.

FIG. 5 is a flowchart diagram of a picking management method according to one or more embodiments of the present invention.

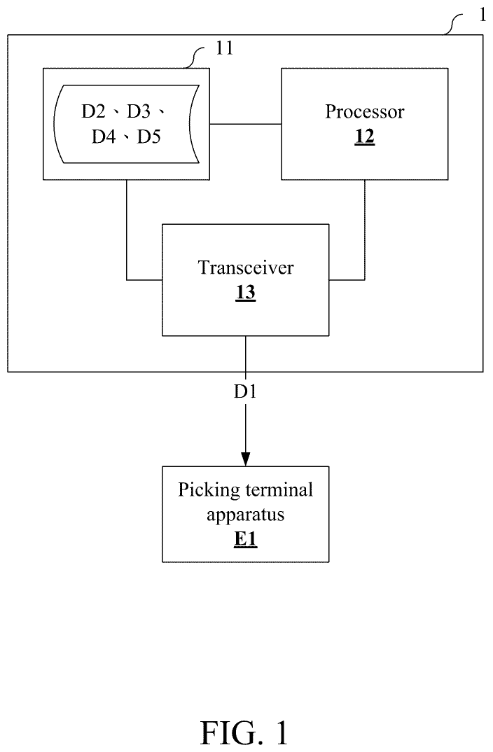

The contents shown in FIG. 1 to FIG. 5 are only provided as exemplary examples for exemplifying embodiments of the present invention and are not intended to limit the scope claimed in the present invention.

### DETAILED DESCRIPTION

Hereinafter, the picking management device, the picking management method and the non-transitory computer-readable medium thereof provided according to certain examples of the present invention will be explained through example embodiments. However, these example embodiments are not intended to limit the present invention to any environments, applications, examples, or implementations described in these example embodiments. Therefore, description of these example embodiments is only for purpose of explaining the present invention rather than for limiting the scope of the present invention. It shall be appreciated that, in the following embodiments and the attached drawings, elements unrelated to the present invention are omitted from depiction; and dimensions of and dimensional scales among individual elements are provided only for illustration, but not to limit the scope of the present invention.

Referring to FIG. 1, a first embodiment of the present invention is a picking management device 1, which may assign picking tasks to a picking terminal apparatus E1 as a whole and provide picking sequence data D1. The picking management device 1 may be various kinds of electronic computing devices with computing processing capabilities, such as but not limited to desktop computers, notebook computers, servers, mobile phones, and portable electronic accessories (watches, glasses, etc.) In some embodiments, like the picking management device 1, the picking terminal apparatus E1 may be various kinds of electronic computing devices with computing processing capabilities, and it is operated by a picker. The picker may perform corresponding picking operations in a picking field according to the picking sequence data D1 received by the picking terminal apparatus E1. In some embodiments, the picking terminal apparatus E1 may also be an automation picking machine (e.g., a picking trolley with computer functions and capable of moving by itself), which can automatically perform corresponding picking operations by itself in the picking field according to the received picking sequence data D1.

The picking management device 1 may basically comprise a storage 11, a processor 12 and a transceiver 13, and the storage 11, the processor 12 and the transceiver 13 may be electrically connected to each other. The storage 11, the processor 12 and the transceiver 13 may be electrically connected directly (i.e., connected to each other without through other elements) or indirectly (i.e., connected to each other through other elements).

The storage 11 may be configured to store data generated by the picking management device 1, data input from external devices, or data input by users themselves. The storage 11 may comprise a primary memory (also referred to as a main memory or an internal memory), and the processor 12 may directly read instruction sets stored in the primary memory and execute these instruction sets if necessary. The storage 11 may optionally comprise a secondary memory (also referred to as an external memory or an auxiliary memory), and this memory may transfer the stored data to the primary memory through a data buffer. For example, the secondary memory may be, but not limited to, a hard disk, an optical disk, etc. The storage 11 may optionally comprise a tertiary memory, that is, a storage device that can be directly inserted into or removed from the computer, such as a portable hard disk.

The processor 12 may be a microprocessor or microcontroller with signal processing function. The microprocessor or microcontroller is a kind of programmable specific integrated circuit that is capable of operating, storing, outputting/inputting or the like, and it may receive and process various coded instructions, thereby performing various logical operations and arithmetical operations and outputting corresponding operation results. The processor 12 may be programmed to interpret various instructions to process data in the picking management device 1 and execute various operation procedures or programs.

The transceiver 13 may comprise a transmitter and a receiver. Taking wireless communication as an example, the transceiver 13 may comprise, but not limited to, an antenna, an amplifier, a modulator, a demodulator, a detector, an analog-to-digital converter, a digital-to-analog converter, and other communication elements. Taking wired communication as an example, the transceiver 13 may be for example, but not limited to, a gigabit Ethernet transceiver, a gigabit interface converter (GBIC), a small form-factor pluggable (SFP) transceiver, a ten-gigabit small form-factor pluggable (XFP) transceiver or the like.

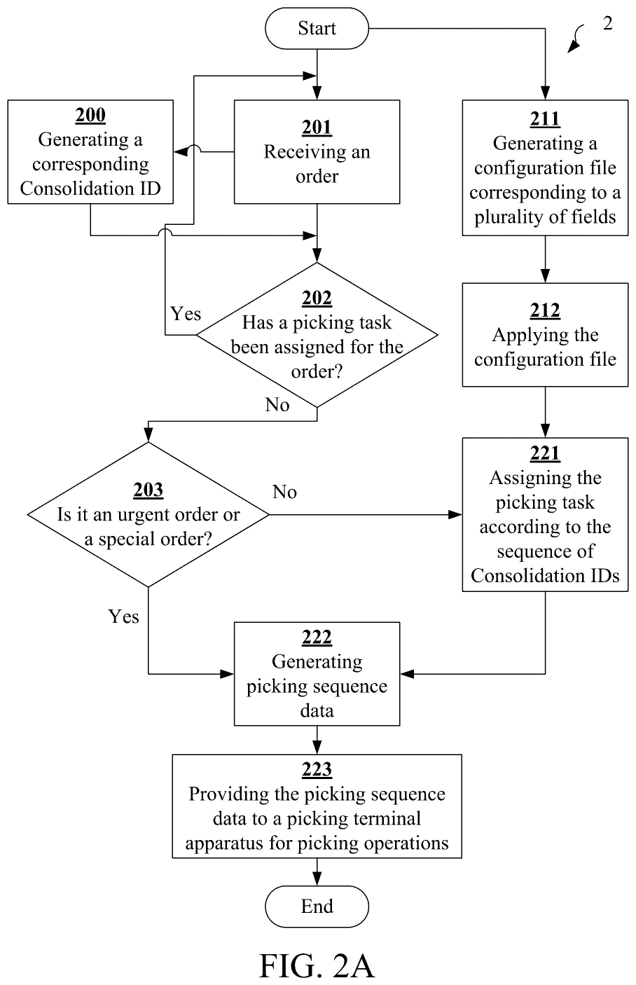

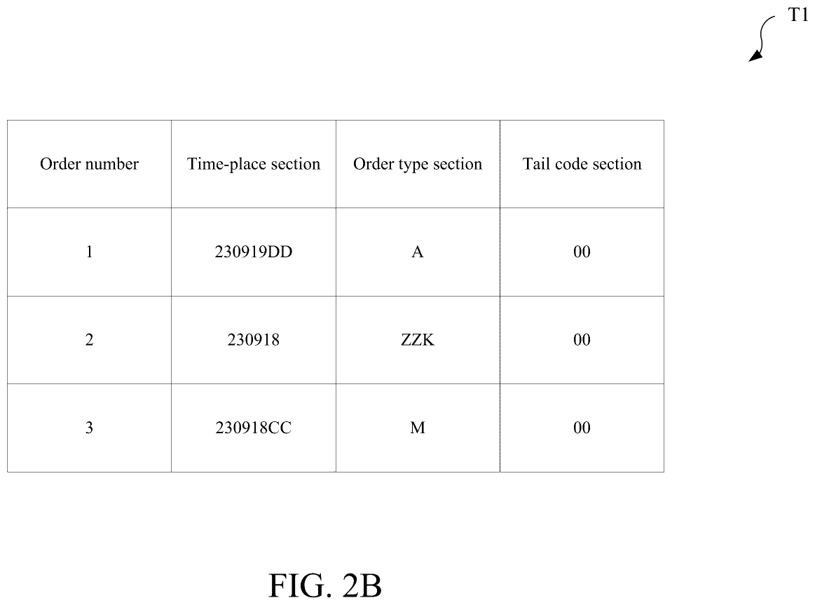

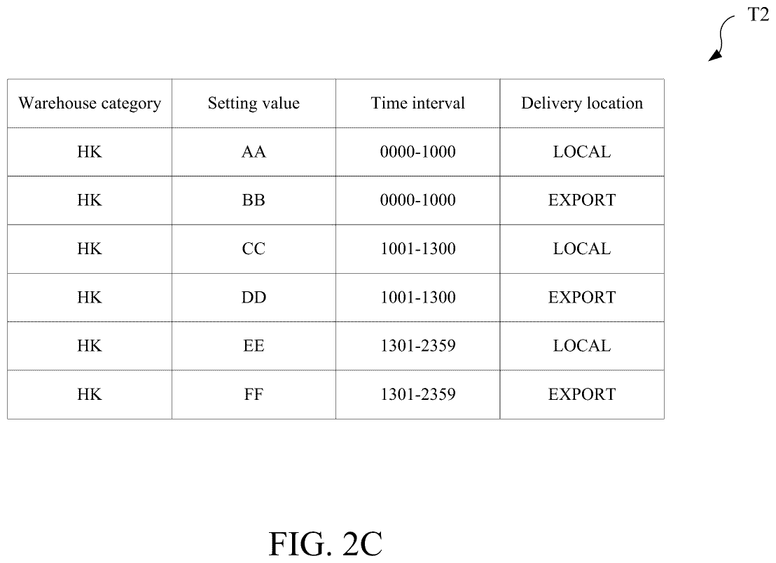

Referring to FIG. 2A, there is shown a flow 2 of the picking management device 1 performing picking path arrangement after receiving an order. The flow 2 may start from an action 201 in which the picking management device 1 may receive a piece of order data through the transceiver 13. Then, in an action 202, the processor 12 may determine whether a corresponding picking task has been assigned for the received order data, that is, whether any corresponding picker/automated picking apparatus, picking sequence data (which may be previously designed historical data or data manually assigned by the user) or other information has existed for the piece of order data in the database record of the picking management device 1. If the result of the determination is yes, then the transceiver 13 may continue to receive the next piece of order data. Otherwise, the subsequent actions may be performed.

In an action 203, the processor 12 may then determine whether the piece of order data belongs to an urgent order or a special order. The urgent order may refer to the order data that the time difference between the current time and any one of a corresponding estimated distribution time, a picking time, a labeling time, a quality control time, a arrival time of all goods, a vehicle dispatching time, a warehouse departure time, a goods arrival time is shorter than a threshold (e.g., one day). The special order may refer to the order data corresponding to items such as a specific goods delivery customer, a goods receiving customer and a transportation destination. The users can set the specific definitions of the urgent order and the special order themselves.

If the processor 12 determines that the piece of order data does not belong to an urgent order or a special order, then an action 221 may be performed then to arrange the sequence of picking orders. On the contrary, if the processor 12 determines that the piece of order data belongs to an urgent order or a special order, then an action 222 may be directly performed as appropriate to directly generate the corresponding picking sequence data D1 for the order.

In some embodiments, before performing any of the above-mentioned actions 202, 203 and 221, the processor 12 may first generate a Consolidation ID for each piece of order data in an action 200. The format of each of the Consolidation IDs may be as shown in a table T1 illustrated in FIG. 2B. Please refer to FIG. 2B. It should be noted that the length of the Consolidation IDs is uniformly set to 11 codes in the table T1, so as to facilitate the description of the contents and aspects of each section, but this length is not the only feasible embodiment of the Consolidation IDs. Actually, users may customize the ideal Consolidation ID length according to their requirements.

As shown in the table T1, the corresponding Consolidation IDs generated by the processor 12 according to the contents of the order data may comprise a time-place section, an order type section, and a tail code section. Firstly, a time-place section code in the time-place section may be configured to indicate attributes related to the specific time type and delivery location or other information in the corresponding order data. Accordingly, the processor 12 can generate a time-place section code with a specific length according to the following time and place information which the order data correspond to in the database: an estimated distribution time, a picking time, a labeling time, a quality control time, an arrival time of all goods, a vehicle dispatching time, a warehouse departure time, a goods arrival time, a time difference between any two of the above, or a delivery location.

The time-place section code may purely consist of digits or consist of a combination of digits and characters, and it may have a length of, such as, but not limited to, six codes or eight codes to indicate the year, month, and day which the above-mentioned time information corresponds to. For example, the Consolidation ID corresponding to the order number “1” in the table T1 corresponds to a format of six codes of digit plus two codes of English characters, wherein the first six codes of digit may be used to indicate the information of year A.D., month and day, and the last two codes of English characters may be used to indicate time intervals which different distribution places correspond to (e.g., LOCAL and EXPORT). In some embodiments, users may define the customized section according to the transportation information which the order data corresponds to, such as the relations shown in a table T2 illustrated in FIG. 2C.

Referring to FIG. 2C, in the table T2, the warehouse category column indicates warehouse categories which transportation destinations correspond to, the setting value column indicates the last two codes of English characters mentioned above, the time interval column indicates intervals which arrival times correspond to, and the delivery location column indicates whether the transportation type is local transportation or international (export) transportation.

Then, the order type code in the order type section may be used to indicate attributes of the whole piece of order data. For example, if the corresponding order data belongs to a general order, then the order type code thereof may be “A,” as shown by the order type section corresponding to the order number “1” in the table T1.

For another example, if the corresponding order data belongs to a special order, for example, corresponds to a special delivery customer, an order placing customer or the like, then the order type code may be used to indicate the attribute corresponding to the customer number, such as “ZZK” corresponding to the order mark “2” shown in the table T1. In addition, the order type code may also be used to define a special picking mode, or even define whether the order belongs to an urgent order or not.

For another example, a specific place of digit in the Consolidation ID may be designated as a code indicating a specific meaning, as shown by the order type section corresponding to the order number “3” in the table T1, wherein it is defined to fixedly display “M” for the ninth code. If the picker and/or the automated picking apparatus recognizes “M” in the ninth digit of the Consolidation ID, then they can perform picking operations through a work order number accordingly.

As for the tail code in the tail code section, any string could be filled therein, thereby adjusting the Consolidation ID to a specific length.

Still referring to FIG. 2A, in action 221, the processor 12 may take a sequence of Consolidation IDs as a picking sequence of a plurality pieces of order data. In some embodiments, the sequence may be a sequence sorted from small to large according to the time-place sections in the Consolidation IDs.

In some embodiments, actually, an urgent order and a special order can also be distinguished by the order type section in the Consolidation IDs, so if the processor 12 determines that the order data belongs to an urgent order or a special order at the stage of action 221, then the above-mentioned sequence of the Consolidation IDs can be ignored and the order data belonging to an urgent order or a special order can be sorted with the highest priority.

After determining the picking sequence of the orders, the processor 12 may assign pickers and/or automated picking apparatuses corresponding to respective orders in sequence. However, in some embodiments, the processor 12 may firstly generate a configuration file corresponding to a plurality of fields in the warehouse in an action 211 before assigning picking tasks to specific pickers and/or automated picking apparatuses. The configuration file is used to realize cross-field cooperative picking.

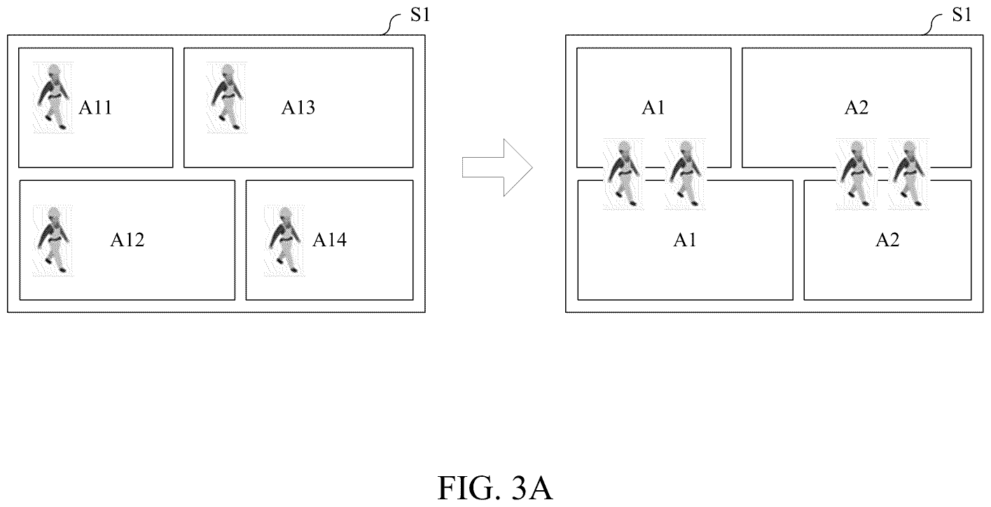

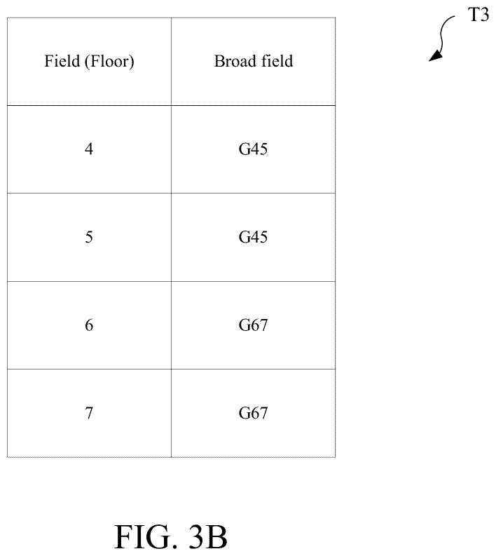

Specifically, referring to FIG. 3A, a warehouse S1 illustrated in FIG. 3A may comprise four picking fields, namely a field A11, a field A12, a field A13 and a field A14. The field may refer to different floors in the warehouse S1 or different areas on the same floor.

The processor 12 may generate a configuration file at least comprising one field column and a special mapping column for the above-mentioned four fields. The field column is used to indicate various fields, i.e., the existing fields A11, A12, A13 and A14. The special mapping column may be used to indicate a broad field corresponding to each field, and the broad field may include at least one field. For example, the processor 12 may define the field A11 and the field A12 as a broad field A1 and define the field A13 and the field A14 as a broad field A2 at the same time, and record the broad fields which each field corresponds to in the configuration file, and the concept thereof may be as shown in a table T3 illustrated in FIG. 3B.

Please refer to FIG. 3B. Fields in the table T3 refer to floors in the warehouse, from which it can be known that in this configuration file, the original fourth and fifth floors are defined as a broad field numbered as “G45”, and the original sixth and seventh floors are defined as a broad field numbered as “G67”.

In some embodiments, the configuration file may also comprise a warehouse category column, which is used to indicate the warehouse where each field is located.

Then, in an action 212, the processor 12 may apply the configuration file to perform picking task assignment based on the broad field instead, so that pickers and/or automated picking apparatuses corresponding to the same broad field may support each other, thereby jointly undertaking picking tasks in multiple original fields corresponding to the broad field. By applying the configuration file, in action 221, the processor 12 can assign picking tasks originally corresponding to, for example, the field A11 to pickers and/or automated picking apparatuses originally corresponding to the field A12 (because they all correspond to the broad field A1), thereby realizing cross-field picking cooperation.

Still referring to FIG. 2A, in action 222, the processor 12 may generate corresponding picking sequence data D1 for each piece of order data to be picked, that is, which path sequence should pickers and/or automated picking apparatuses that responsible for the order adopt to perform picking in the corresponding field.

To generate the picking sequence data D1, the processor 12 may first convert the corresponding storage location data D4, storage location-aisle distribution diagram D5, and storage space spacing data D2 based on a floor plan of the target area corresponding to the picking task (hereinafter referred to as “target area,” which in some embodiments may also refer to the aforementioned broad category of areas). The floor plan may be an image file in CAD format, containing the layout of buildings, storage spaces, and aisles corresponding to the target area. In some embodiments, this image may be received externally by the transceiver 13. However, in some other embodiments, it can also be generated by the processor 12 itself through the execution of drawing software.

The processor 12 may present portions corresponding to storage spaces in the floor plan in a first color (e.g., white) and present other portions except for the storage spaces in a second color (e.g., black), thereby converting the floor plan into a storage space map that only emphasizes storage spaces. The processor 12 may further mark each storage space with coordinates on the storage space map, thereby integrating coordinate information of respective storage spaces into storage space location data D4 and storing it in the storage 11.

In addition, the processor 12 may also present portions corresponding to aisles in the floor plan in the above-mentioned second color (e.g., also in black), and present other portions except for aisles in the above-mentioned first color (e.g., also in white), thereby converting the floor plan into an aisle map only emphasizing aisles and storing it in the storage 11.

The above-mentioned first color (e.g., white) may be used to indicate locations where pickers and/or automated picking apparatuses cannot access or are not allowed to access, while the above-mentioned second color (e.g., black) may be used to indicate locations where pickers and/or automated picking apparatuses can access or are allowed to access.

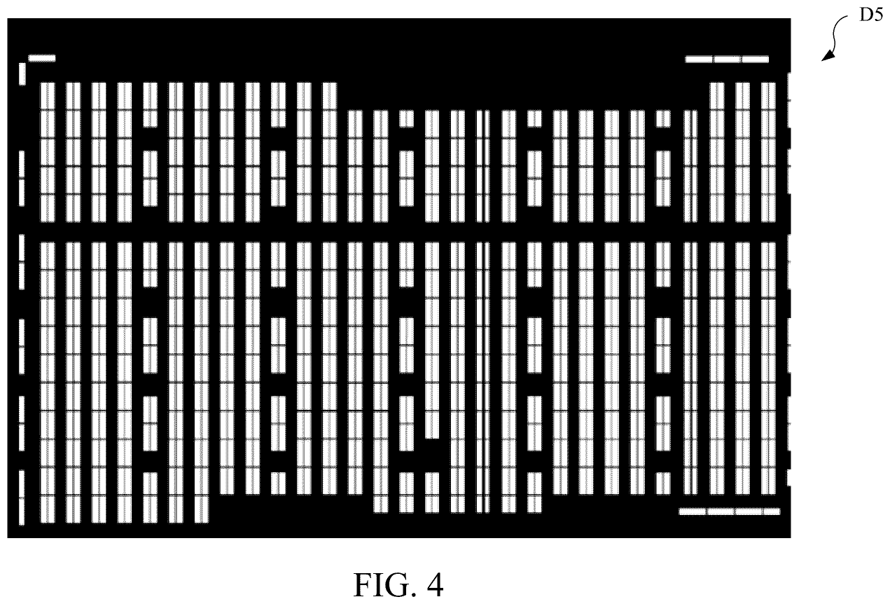

Then, the processor 12 may convert the above-mentioned storage space map and aisle map into a storage space-aisle distribution diagram D5, as shown in FIG. 4, wherein locations where pickers and/or automated picking apparatuses can access or are allowed to access are all presented in black, while locations where picker and/or automated picking apparatuses cannot access or are not allowed to access (i.e., storage spaces, walls or other buildings) are all presented in white. It shall be noted that the contents shown in FIG. 4 are only schematic, and the size and length proportion relationships between storage spaces and aisles shown therein are not intended to be limiting.

In some embodiments, the processor 12 may also directly present storage spaces, aisles and other areas in the floor plan in three colors, so that locations where pickers and/or automated picking apparatuses can access or are allowed to access can be directly distinguished by the three colors.

Therefore, through an optimization search algorithm in combination with the determination of color brightness values (e.g., values from 0 to 255 for three channels of red, green and blue (RGB)), the processor 12 may move in any direction each time by a distance of a specific unit (e.g., a pixel) from coordinates where a starting storage space is located to an ending storage space in areas where pickers and/or automated picking apparatuses can access or are allowed to access on the storage space-aisle distribution diagram D5, and record the path length and path calculated between the two storage spaces.

The processor 12 may repeatedly perform the above-mentioned actions, and take storage spaces in the target field as the starting storage space or the ending storage space in turn until path lengths and corresponding paths between all the storage spaces in the target field are calculated, and the results are integrated into the storage space spacing data D2. For example, the storage space spacing data D2 may be a matrix or an array in which each element indicates the optimal path length between any two storage spaces, but the form of the storage space spacing data D2 is not limited to the matrix or the array.

The optimization search algorithm may specifically be a Greedy algorithm or a Heuristic algorithm, such as, but not limited to, a Depth First Search (DFS) algorithm, a Genetic algorithm, a Tabu Search algorithm, and the like.

In some embodiments, the processor 12 may continuously maintain the storage space spacing data D2 to respond to changes in the distribution of storage spaces and aisles in the target field. In addition, in some embodiments, different warehouses and fields (floors and/or planes) may have their own storage space spacing data.

On the other hand, the processor 12 may generate corresponding data of storage space to be picked D3 according to the order data and store it in the storage 11. The data of storage space to be picked D3 may include storage space information of goods corresponding to the piece of order data, i.e., indicating which storage spaces need to be picked.

After knowing the storage space spacing data D2 and the data of storage space to be picked D3, the processor 12 may then perform an action (A), that is, determining from data of storage space to be picked D3, a storage space to be picked closest to a current location (i.e., one of a plurality of storage spaces listed in the data of storage space to be picked D3) according to the storage space spacing data D2. Since the order data has been assigned to a specific picker and/or automated picking apparatus, in some embodiments, the transceiver 13 may receive, from the computing apparatus held by the picker and/or the automated picking apparatus itself (i.e., the picking terminal apparatus E1), information of the location where the apparatus currently is located as the current location.

After determining the storage space to be picked closest to the current location, the processor 12 can accordingly update the current location into the determined storage space to be picked, and then remove the storage space to be picked from the data of storage space to be picked D3.

The processor 12 may then perform an action (B), that is, according to the storage space spacing data D2, storage space location data D4 and a storage space-aisle distribution diagram D5, determining the next closest storage space to be picked in the same aisle as the current location in the data of storage space to be picked D3, and similarly updating the current location accordingly and removing the determined storage space to be picked from the data of storage space to be picked.

In an action (C), the processor 12 may repeat the above-mentioned action (B) until there is no longer any storage space to be picked in the same aisle as the current location in the data of storage space to be picked D3, i.e., until the picking sequence arrangement of the same aisle is completed.

Next, in an action (D), the processor 12 may repeat the above-mentioned actions (A), (B), and (C) until the data of storage space to be picked D3 is cleared. At this point, all the storage spaces listed in the data of storage space to be picked D3 have been used to update the current location, so the processor 12 can generate picking sequence data D1 based on a change history of the current location.

Then, in an action 223, the transceiver 13 may provide the picking sequence data D1 to the picking terminal apparatus E1, so that the picking terminal apparatus E1 can perform picking operations accordingly in the target field. In some embodiments, the action that the picking terminal apparatus E1 performs picking operations may refer to the action that the picking terminal apparatus E1 notifies and displays the picking sequence data D1 to the corresponding picker, so that the picker can accordingly perform corresponding manual picking operations in the target field. In some other embodiments, the picking operations performed by the picking terminal apparatus E1 may refer to unmanned automation picking operations performed by the automated picking apparatus in the target field according to the picking sequence data D1.

According to the above descriptions, the picking management device 1 can calculate the corresponding optimal picking path according to the current location of the picking terminal apparatus E1. Although the optimal picking path may not necessarily be the shortest picking path of the corresponding piece of order data, the transition between aisles is avoided as much as possible. In addition, in combination with the storage space spacing data maintained by the picking management device 1 for the target field based on the optimization algorithm, the processing efficiencies of both front-end practical operations of pickers and/or automated picking apparatuses in the target field or the corresponding back-end picking management operations are obviously improved.

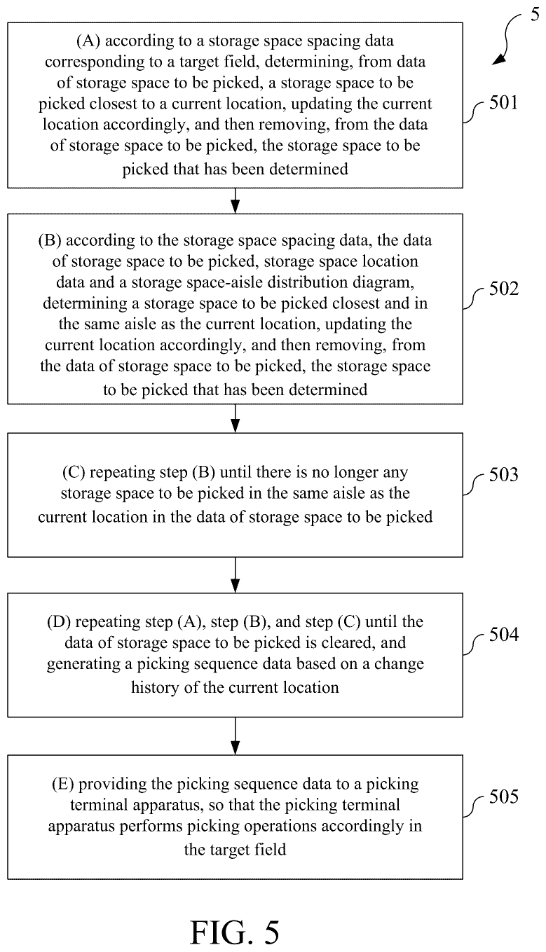

Referring to FIG. 5, a second embodiment of the present invention is a picking management method 5, which may be executed by a computing device and may comprise the following steps:
(A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined (marked as 501);
(B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined (marked as 502);
(C) repeating step (B) until there is no longer any storage space to be picked in the same aisle as the current location in the data of storage space to be picked (marked as 503);
(D) repeating step (A), step (B), and step (C) until the data of storage space to be picked is cleared, and generating a picking sequence data based on a change history of the current location (marked as 504); and
(E) providing the picking sequence data to a picking terminal apparatus, so that the picking terminal apparatus performs picking operations accordingly in the target field (marked as 505).

In some embodiments, the picking management method 5 may further comprise the following step: calculating a distance between any two of a plurality of picking storage spaces through an optimization search algorithm according to the storage space location data and the storage space-aisle distribution diagram, thereby generating the storage space spacing data.

In some embodiments, the picking management method 5 may further comprise the steps of “generating a storage space map and an aisle map according to a floor plan of the target field” and “generating the storage space location data and the storage space-aisle distribution diagram according to the storage space map and the aisle map”.

In some embodiments, for the picking management method 5, the storage space-aisle distribution diagram may present an area where a picker and/or an automated picking apparatus which the picking terminal apparatus belongs to are not allowed to access in the target field in a first color, and present an area where the picker and/or the automated picking apparatus are allowed to access in the target field in a second color different from the first color. In some embodiments, for the picking management method 5, the data of storage space to be picked may correspond to one of a plurality of order data, and the picking management method 5 may further comprise the steps of “generating a plurality of corresponding Consolidation IDs according to the plurality pieces of order data, wherein each of the plurality of Consolidation IDs comprises a time-place section and an order type section” and “taking a sequence of the plurality of Consolidation IDs as a picking sequence of the plurality pieces of order data”. In addition, in some embodiments, the time-place section may correspond to the following information of corresponding order data: an estimated distribution time, a picking time, a labeling time, a quality control time, a arrival time of all goods, a vehicle dispatching time, a warehouse departure time, a goods arrival time, a time difference between any two of the above, or a delivery location. In some embodiments, the order type section may correspond to at least one of the following information of corresponding order data: a delivery customer, an order placing customer and a picking mode. In some embodiments, the sequence may be a sequence sorted from small to large according to the plurality of time-place sections included in the plurality of Consolidation IDs.

In some embodiments, the picking management method 5 may further comprise the step of “generating a configuration file corresponding to a plurality of fields”, and the configuration file may comprise a field column being used to indicate each of the fields and a special mapping column being used to indicate a broad field corresponding to each of the fields. The broad field may include at least one field. Besides, the picking management method 5 may further comprise the steps of “applying the configuration file to define a first field and a second field in the plurality of fields as a first broad field” and “assigning a picking task originally corresponding to the first field to a picker originally corresponding to the second field according to the configuration file, thereby realizing cross-field picking cooperation”. Further, in some embodiments, the target field may be the first broad field.

Each embodiment of the picking management method 5 basically corresponds to a certain embodiment of the picking management device 1. Therefore, all the corresponding embodiments of the picking management method 5 can be fully appreciated and realized by those of ordinary skill in the art simply with reference to the above description of the picking management device 1, even though not all the embodiments of the picking management method 5 are described in detail above.

A third embodiment of the present invention is a non-transitory computer-readable medium. When the non-transitory computer-readable medium is loaded into a computing device (e.g., the above-mentioned picking management device 1), the instructions in the non-transitory computer-readable medium may be read to execute the corresponding steps of each embodiment of the picking management method 5 described in the second embodiment. The non-transitory computer-readable medium may be a tangible object loading with a computer-readable program, such as a non-transitory tangible machine-readable medium. The non-transitory tangible machine-readable medium may include: a non-transitory tangible machine-readable medium, a read-only memory (ROM), a flash memory, a floppy disk, a mobile hard disk, a magnetic tape, a network database, a cloud node, or other tangible objects. In some embodiments, the non-transitory computer-readable medium may also be a computer program product, and the computer program product refers to an object carrying computer-readable programs and not limited to external forms, which is loaded by the computing device through various network transmissions.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A picking management device, comprising:
a processor, comprising being configured to perform the following actions:
(A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined;
(B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined;
(C) repeating action (B) until there is no longer any storage space to be picked in the same aisle as the current location in the data of storage space to be picked; and
(D) repeating action (A), action (B), and action (C) until the data of storage space to be picked is cleared, and generating picking sequence data based on a change history of the current location; and
a transceiver, being electrically connected with the processor and being configured to provide the picking sequence data to a picking terminal apparatus, so that the picking terminal apparatus performs picking operations accordingly in the target field.

2. The picking management device according to claim 1, wherein the processor is further configured to calculate a distance between any two of a plurality of picking storage spaces through an optimization search algorithm according to the storage space location data and the storage space-aisle distribution diagram, thereby generating the storage space spacing data.

3. The picking management device according to claim 1, wherein the processor is further configured to:
generate a storage space map and an aisle map according to a floor plan of the target field; and
generate the storage space location data and the storage space-aisle distribution diagram according to the storage space map and the aisle map.

4. The picking management device according to claim 1, wherein the storage space-aisle distribution diagram presents, in a first color, an area where at least one of a picker and an automated picking apparatus which the picking terminal apparatus belongs to is not allowed to access in the target field, and presents, in a second color different from the first color, an area where the at least one of the picker and the automated picking apparatus is allowed to access in the target field.

5. The picking management device according to claim 1, wherein the data of storage space to be picked corresponds to one of a plurality pieces of order data, and the processor is further configured to:
generate a plurality of Consolidation IDs according to the plurality pieces of order data, wherein the plurality of Consolidation IDs correspond to the plurality pieces of order data, and each of the plurality of Consolidation IDs comprises a time-place section and an order type section; and
take a sequence of the plurality of Consolidation IDs as a picking sequence of the plurality pieces of order data.

6. The picking management device according to claim 5, wherein the time-place section corresponds to the following information of corresponding order data: an estimated distribution time, a picking time, a labeling time, a quality control time, a arrival time of all goods, a vehicle dispatching time, a warehouse departure time, a goods arrival time, a time difference between any two of the above, or a delivery location.

7. The picking management device according to claim 5, wherein the order type section corresponds to at least one of the following information of corresponding order data: a delivery customer, an order placing customer and a picking mode.

8. The picking management device according to claim 5, wherein the sequence of the plurality of Consolidation IDs is a sequence sorted from small to large according to the plurality of time-place sections included in the plurality of Consolidation IDs.

9. The picking management device according to claim 1, wherein the processor is further configured to:
generate a configuration file corresponding to a plurality of fields, wherein the configuration file comprises:
a field column, being configured to indicate each of the fields; and
a special mapping column, being configured to indicate a broad field which each of the fields corresponds to, wherein the broad field includes at least one field;
apply the configuration file to define a first field and a second field in the plurality of fields as a first broad field; and
assign a picking task originally corresponding to the first field to a picker originally corresponding to the second field according to the configuration file, thereby realizing cross-field picking cooperation.

10. The picking management device according to claim 9, wherein the target field is the first broad field.

11. A non-transitory computer-readable medium, after being loaded into a computing device, causing the computing device to read instructions in the non-transitory computer-readable medium so as to execute a picking management method, the picking management method comprising:
(A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined;
(B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined;
(C) repeating step (B) until there is no longer any storage space to be picked in the same aisle as the current location in the data of storage space to be picked;
(D) repeating step (A), step (B), and step (C) until the data of storage space to be picked is cleared, and generating a picking sequence data based on a change history of the current location; and
(E) providing the picking sequence data to a picking terminal apparatus, so that the picking terminal apparatus performs picking operations accordingly in the target field.

12. The non-transitory computer-readable medium according to claim 11, wherein the picking management method further comprises:
calculating a distance between any two of a plurality of picking storage spaces through an optimization search algorithm according to the storage space location data and the storage space-aisle distribution diagram, thereby generating the storage space spacing data.

13. The non-transitory computer-readable medium according to claim 11, wherein the picking management method further comprises:
generating a storage space map and an aisle map according to a floor plan of the target field; and
generating the storage space location data and the storage space-aisle distribution diagram according to the storage space map and the aisle map.

14. The non-transitory computer-readable medium according to claim 11, wherein the storage space-aisle distribution diagram presents, in a first color, an area where at least one of a picker and an automated picking apparatus which the picking terminal apparatus belongs to is not allowed to access in the target field, and presents, in a second color different from the first color, an area where the at least one of the picker and the automated picking apparatus is allowed to access in the target field.

15. The non-transitory computer-readable medium according to claim 11, wherein the data of storage space to be picked corresponds to one of a plurality pieces of order data, and the picking management method further comprises:
generating a plurality of Consolidation IDs according to the plurality pieces of order data, wherein the plurality of Consolidation IDs correspond to the plurality pieces of order data, and each of the plurality of Consolidation IDs comprises a time-place section and an order type section; and
taking a sequence of the plurality of Consolidation IDs as a picking sequence of the plurality pieces of order data.

16. The non-transitory computer-readable medium according to claim 15, wherein the time-place section corresponds to the following information of corresponding order data: an estimated distribution time, a picking time, a labeling time, a quality control time, a arrival time of all goods, a vehicle dispatching time, a warehouse departure time, a goods arrival time, a time difference between any two of the above, or a delivery location.

17. The non-transitory computer-readable medium according to claim 15, wherein the order type section corresponds to at least one of the following information of corresponding order data: a delivery customer, an order placing customer and a picking mode.

18. The non-transitory computer-readable medium according to claim 15, wherein the sequence of the plurality of Consolidation IDs is a sequence sorted from small to large according to the plurality of time-place sections included in the plurality of Consolidation IDs.

19. The non-transitory computer-readable medium according to claim 11, wherein the picking management method further comprises:
generating a configuration file corresponding to a plurality of fields, wherein the configuration file comprises:
a field column, being configured to indicate each of the fields; and
a special mapping column, being configured to indicate a broad field which each of the fields corresponds to, wherein the broad field includes at least one field;
applying the configuration file to define a first field and a second field in the plurality of fields as a first broad field; and
assigning a picking task originally corresponding to the first field to a picker originally corresponding to the second field according to the configuration file, thereby realizing cross-field picking cooperation.

20. The non-transitory computer-readable medium according to claim 19, wherein the target field is the first broad field.

21. A picking management method executed by a computing device, comprising:
(A) according to a storage space spacing data corresponding to a target field, determining, from data of storage space to be picked, a storage space to be picked closest to a current location, updating the current location accordingly, and then removing, from the data of storage space to be picked, the storage space to be picked that has been determined;
(B) according to the storage space spacing data, the data of storage space to be picked, storage space location data and a storage space-aisle distribution diagram, determining a storage space to be picked closest and in the same aisle as the current location, updating the current location accordingly, and then removing, from the data of storage space to be picked, the storage space to be picked that has been determined;
(C) repeating step (B) until there is no longer any storage space to be picked in the same aisle as the current location in the data of storage space to be picked;
(D) repeating step (A), step (B), and step (C) until the data of storage space to be picked is cleared, and generating a picking sequence data based on a change history of the current location; and
(E) providing the picking sequence data to a picking terminal apparatus, so that the picking terminal apparatus performs picking operations accordingly in the target field.

22. The picking management method according to claim 21, further comprising:
calculating a distance between any two of a plurality of picking storage spaces through an optimization search algorithm according to the storage space location data and the storage space-aisle distribution diagram, thereby generating the storage space spacing data.

23. The picking management method according to claim 21, further comprising:
generating a storage space map and an aisle map according to a floor plan of the target field; and
generating the storage space location data and the storage space-aisle distribution diagram according to the storage space map and the aisle map.

24. The picking management method according to claim 21, wherein the storage space-aisle distribution diagram presents, in a first color, an area where at least one of a picker and an automated picking apparatus which the picking terminal apparatus belongs to is not allowed to access in the target field, and presents, in a second color different from the first color, an area where the at least one of the picker and the automated picking apparatus is allowed to access in the target field.

25. The picking management method according to claim 21, wherein the data of storage space to be picked corresponds to one of a plurality pieces of order data, and the picking management method further comprises:
generating a plurality of Consolidation IDs according to the plurality pieces of order data, wherein the plurality of Consolidation IDs correspond to the plurality pieces of order data, and each of the plurality of Consolidation IDs comprises a time-place section and an order type section; and
taking a sequence of the plurality of Consolidation IDs as a picking sequence of the plurality pieces of order data.

26. The picking management method according to claim 25, wherein the time-place section corresponds to the following information of corresponding order data: an estimated distribution time, a picking time, a labeling time, a quality control time, a arrival time of all goods, a vehicle dispatching time, a warehouse departure time, a goods arrival time, a time difference between any two of the above, or a delivery location.

27. The picking management method according to claim 25, wherein the order type section corresponds to at least one of the following information of corresponding order data: a delivery customer, an order placing customer and a picking mode.

28. The picking management method according to claim 25, wherein the sequence of the plurality of Consolidation IDs is a sequence sorted from small to large according to the plurality of time-place sections included in the plurality of Consolidation IDs.

29. The picking management method according to claim 21, further comprising:
generating a configuration file corresponding to a plurality of fields, wherein the configuration file comprises:
a field column, being configured to indicate each of the fields; and
a special mapping column, being configured to indicate a broad field which each of the fields corresponds to, wherein the broad field includes at least one field;
applying the configuration file to define a first field and a second field in the plurality of fields as a first broad field; and
assigning a picking task originally corresponding to the first field to a picker originally corresponding to the second field according to the configuration file, thereby realizing cross-field picking cooperation.

30. The picking management method according to claim 29, wherein the target field is the first broad field.
